(19) United States
(12) Patent Application Publication
(10) Pub. No.: US 2007/0256710 A1
(43) Pub. Date: Nov. 8, 2007

(54) Chemical process operations on wafers having through-holes and a pressure differential between the major surfaces thereof

(75) Inventors: Sophia Ziying Wen, Sandy, OR (US); Anthony W. Humpage, Vancouver, WA (US)

Correspondence Address: RAYMOND J. WERNER, 2056 NW ALOCLEK DRIVE, SUITE 314, HILLSBORO, OR, 97124, US

(73) Assignee: DTL Technologies, Inc.

(21) Appl. No.: 11/827,886

(22) Filed: Jul. 12, 2007

Related U.S. Application Data
(63) Continuation-in-part of application No. 10/865,013, filed on Jun. 10, 2004.

(51) Int. Cl. B08B 9/00

(52) U.S. Cl. 134/22.1

(57) ABSTRACT

Post-etch cleaning of through-holes, or deep vias, in a wafer includes introduction of a cleaning agent to a first major surface of the wafer establishing a pressure differential across the wafer, and removing the cleaning agent from both sides of the wafer. An apparatus provides for receiving and holding a wafer within a chamber; establishing a reservoir adjacent each of a first and second major surface of the wafer; each reservoir being an enclosed space defined by the inner surface of a portion of the chamber, and a major surface of the wafer. In some embodiments a gasket, such as an O-ring, is provided to form the seal between the chamber and the wafer. Alternatively, a seal between chamber and wafer is obtained by contacting the chamber directly to an outer annular portion of the wafer and applying pressure. Post-etch cleaning of through-holes includes providing a first sealed reservoir adjacent a first major surface of a wafer, providing a second sealed reservoir adjacent a second major surface of the wafer, injecting a first cleaning agent into the first sealed reservoir, establishing a pressure differential between the first and second reservoirs, and removing the first cleaning agent from the first and second reservoirs.

### CROSS-REFERENCE TO RELATED APPLICATIONS

This is a continuation-in-part of application Ser. No. 10/865,013, filed 10 Jun. 2004, and entitled “Method And Apparatus For Dynamic Thin-Layer Chemical Processing Of Semiconductor Wafers”, the entirety of which is hereby incorporated by reference.

### FIELD OF THE INVENTION

The present invention relates generally methods and apparatus for chemical processing of substrates such as semiconductor wafers. More particularly, the present invention relates to cleaning through-holes in semiconductor wafers.

### BACKGROUND

Advances in semiconductor manufacturing technology have provided engineers and designers with the capability of producing large, dense, high performance integrated circuits. Over many years, these advances in semiconductor manufacturing technology have related to all aspects of producing structures such as transistors, and other active and passive electrical components, as well as sophisticated interconnection and insulation structures. It is well-known that these transistors and interconnections reside within a very short distance of the surface of a wafer. More recently, structures that are, dimensionally, not so tightly coupled to the wafer surface have been investigated and manufactured. Microelectromechanical systems (MEMS) are one example of such structures. Another example of a structure that is not so tightly coupled to the active surface of a wafer is the through-hole, or deep via. One application of through-holes is to provide a pathway for conductors for stacked integrated circuits.

Through-holes, or deep vias, provide an opening all the way through a wafer from a first major surface to an opposing second major surface. Since the through-hole structure traverses the entire thickness of the wafer, as opposed to being within a micron or so of the surface, processing steps must be devised for their production which are different than those used for conventional structures, which reside within a very short distance of the surface. Although dependent of the specifics of opening size and substrate thickness, through-holes tend to have high aspect ratios, which are generally associated with difficulty in being able to access the structure for thorough post-etch cleaning.

What is needed are methods and apparatus for providing effective chemical processing of through-holes in wafers.

### SUMMARY OF THE INVENTION

Briefly, post-etch cleaning of through-holes, or deep vias, in a wafer includes introduction of at least one cleaning agent to at least a first major surface of the wafer and establishing a pressure differential across the wafer, and removing the at least one cleaning agent from both sides of the wafer. Various embodiments of the present invention provide an apparatus for receiving and holding a wafer within a chamber; establishing a reservoir adjacent each of a first and second major surface of the wafer; each reservoir being an enclosed space comprising the inner surface of a portion of the chamber, and a major surface of the wafer. In some embodiments a gasket, such as an O-ring is provided to form the seal between the chamber and the wafer. In other embodiments, a seal between the chamber and the wafer is obtained simply by contacting the chamber directly to an outer annular portion of the wafer and applying pressure. In accordance with the present invention, post-etch cleaning of through-holes includes providing a first sealed reservoir adjacent a first major surface of a wafer, providing a second sealed reservoir adjacent a second major surface of the wafer, introducing, or injecting, a first cleaning agent into the first sealed reservoir, establishing a pressure differential between the first and second reservoirs, and removing the first cleaning agent from the first and second reservoirs.

In a further aspect of the present invention, chemical processing of wafers includes introduction of at least one processing chemical to at least a first major surface of the wafer and establishing a pressure differential between the first and second major surfaces of the wafer. Chemical processing may include, but is not limited to, wet processing, passivating, cleaning, etching, and plating.

### BRIEF DESCRIPTION OF THE DRAWINGS

FIG. 1 is a cross-sectional view of processing apparatus in accordance with the present invention that provides a pressure differential across a wafer to facilitate driving processing chemicals throughout the length of through-holes in the wafer.

FIG. 2 is a flow diagram of an illustrative embodiment of the present invention.

FIG. 3 is a cross-sectional view similar to that of FIG. 1, which additionally shows a pair of O-rings, a first one disposed between a first major surface of the wafer and the upper wafer support ring and a second one disposed between a second major surface of the wafer and the lower wafer support ring.

### DETAILED DESCRIPTION

Generally, the present invention relates to wafer processing operations, such as for example, cleaning. More particularly, the present invention relates to post-etch cleaning of through-holes, or deep vias, in a wafer. Various embodiments of the present invention provide an apparatus for receiving and holding a wafer within a two-part chamber; establishing a reservoir adjacent each of a first and second major surface of the wafer; each reservoir being an enclosed space comprising the inner surface of a portion of the chamber, and a major surface of the wafer. In some embodiments a gasket, such as an O-ring is provided to form the seal between the chamber and the wafer. In other embodiments, a seal between the chamber and the wafer is obtained simply by contacting the chamber directly to an outer annular portion of the wafer and applying pressure. In accordance with one aspect of the present invention, post-etch cleaning of through-holes includes providing a first sealed reservoir adjacent a first major surface of a wafer, providing a second sealed reservoir adjacent a second major surface of the wafer, injecting, or otherwise introducing, a first cleaning agent into the first sealed reservoir, establishing a pressure differential between the first and second reservoirs, and removing the first cleaning agent from the first and second reservoirs.

It will be appreciated that the wafer, or other substrate to be processed is disposed between upper and lower chamber portions and therefore forms an integral part of the first and second sealed reservoirs. With respect to the expression “sealed reservoir”, as used herein this refers to the space generally enclosed by a chamber portion and a wafer, or other substrate. As used herein, this generally enclosed space also refers to configurations in which there are one or more through-holes in the wafer or other substrate. In other words, the expression “sealed reservoir” is referring to the same space regardless of whether the wafer, or other substrate, has through-holes therein.

In other aspects of the present invention, chemical processing of wafers is achieved while a pressure differential is provided across the wafer, that is, between the two major surfaces of the wafer. Such chemical processing includes wet processing and application of one or more gases. The wafer processing operations achieved in this way include, but are not limited to, cleaning, etching, passivating, and plating. In some embodiments, the surfaces of through-holes are etched in a controlled, i.e., substantially uniform, manner.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

In accordance with the present invention, an apparatus suitable for cleaning through-holes, which may also be referred to as deep vias, in semiconductor wafers, generally includes an upper and a lower chamber. This two-part chamber arrangement is different from conventional unitary wafer processing chamber assemblies. Although a variety of substrates may be processed in accordance with the present invention, illustrative embodiments are designed to hold a semiconductor wafer within the two-part chamber that encloses the wafer to be processed. In the illustrative embodiments described herein, a horizontal wafer positioning within the chamber is assumed. It is noted, however, that all other alignments, up to and including a vertical alignment, are also possible, and such is comprehended by the present invention.

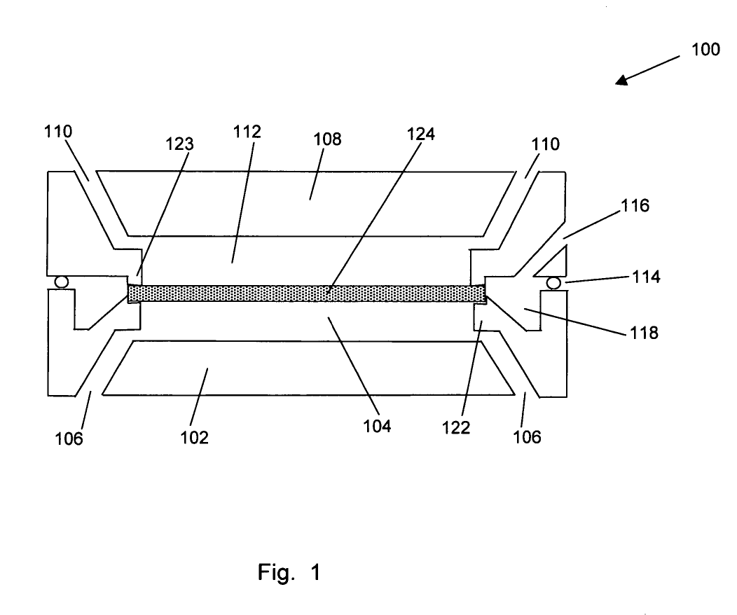

Referring to FIG. 1, a processing chamber 100 suitable for creating a pressure differential across a wafer 124 is shown. More particularly, a lower chamber 102 including inlet/outlet ports 106, and an upper chamber 108 including inlet/outlet ports 110 form two halves, or portions, of processing chamber 100. Upper chamber 108 further includes a pressure control vent 116, and lower chamber 104 includes drain ring 118. Wafer 124 is placed between lower chamber 102 and upper chamber 108, and the upper and lower chambers are brought together to make contact with wafer 124 at lower wafer support ring 122 and upper wafer support ring 123. In typical embodiments, the pressure applied to the wafer is substantially even across the area of contact of the wafer support rings 122, 123 with wafer 124. An O-ring 114 is disposed between upper chamber 108 and lower chamber 102 as shown in FIG. 1. The space between upper chamber 108 and wafer 124 is referred to generally as a sealed reservoir, and is shown in FIG. 1 as upper reservoir 112. The space between lower chamber 102 and wafer 124 is also referred to generally as a sealed reservoir, and is shown in FIG. 1 as lower reservoir 104. In an alternative embodiment, an O-ring 120 is installed in at least one upper wafer support ring 123 and lower wafer support ring 122.

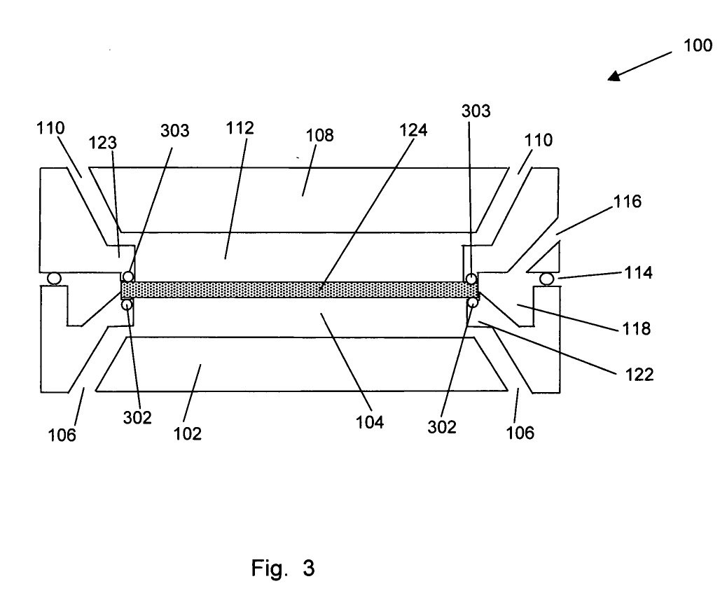

Referring to FIG. 3 an apparatus similar to that of FIG. 1 is shown, which additionally shows a pair of O-rings 302, 303, a first one 303 disposed between a first major surface of wafer 124 and the upper wafer support ring 123 and a second one 302 disposed between a second major surface of wafer 124 and the lower wafer support ring 122.

When closed, the chamber is sealed, with the wafer held tightly by contact pressure surfaces or support rings which are located in the upper and lower chamber surfaces. These contact surfaces hold the wafer all around its edge, and create a seal. As noted above, the chamber may also be configured to work with a variety of other forms of substrates that have holes completely through the substrate, and require uniform cleaning or wet processing of the holes.

In order to allow the upper and lower chamber to be moved from an open position to a closed position, a mechanism is included to provide this functionality. It will be appreciated that a mechanism to provide such motion may be pneumatic, hydraulic, mechanical, or any other suitable arrangement.

When the chamber is open, i.e., separated into two parts, a wafer can be inserted therein. When closed, the chamber seals around the wafer, firmly holding the wafer in position through contact surfaces in the upper and lower portions of the chamber. In various embodiments of the present invention, the amount of pressure exerted by the chamber on the wafer at the points of contact is adjustable. In some embodiments, the pressure is controlled to remain substantially constant throughout the processing of the wafer. In other embodiments, the pressure may be varied during the course of processing to accommodate differing requirements for pressure within the chamber during a variety of processing steps.

Wafer Mounting Within the Chamber

The chamber configuration is designed to hold the wafer tightly by squeezing the wafer in a continuous ring on its upper and lower major surfaces close to the peripheral edge, i.e., the area where there are generally no active components at the edge of the wafer surface. If higher pressures are necessary in order to clean the holes in the wafer, the width of the mounting area around the edge of the wafer may be increased by appropriate reduction in the active processing area on the surface of the wafer.

A seal may be created by having flat Teflon® or other plastic surfaces that can press on the upper and lower wafer surface. Sufficient pressure is applied by the chamber to create a seal around the edge of the wafer, thus allowing a pressure differential to be applied across the wafer.

In some embodiments, the seal between the upper and lower chamber portions is achieved by using an O-rings around the edge of the wafer. It is noted that such an O-ring may be of unitary construction, which is preferred, of the O-ring may be comprised of two or more sections that are fitted together. It is further noted that the O-ring, or similar gasket, may be formed of any suitable material, for environment in which it is intended to be used.

A positioning lip is established in either the upper or lower chamber surface to fit around the edge of the wafer to ensure that the wafer remains properly positioned as the chamber is closed.

In an alternative embodiment, a seal is created by holding the wafer at its edge. This will reduces the contact area on the major surfaces of the wafer. This can be achieved by creating a tapered/angled surface in the lower chamber. The tapered area is precisely machined to match the outer shape of the wafer. In this embodiment, the upper chamber has two or more contact points that press around the edge of the upper surface of the wafer, pressing the wafer down into the tapered lower chamber. The contact points provide the necessary pressure to hold the wafer firmly in the tapered area in the lower chamber, and ensure that the wafer remains oriented as desired, horizontal in this case. A seal is created by the contact of the edge of the wafer to the tapered area in the lower chamber surface. In a further alternative, this seal may be improved by the application of an O-ring immediately next to the ring of contact between the edge of the wafer and the tapered area.

Shape of Chamber

In one embodiment, a reservoir is established above and below the wafer within the upper and lower portions of the chamber. When the wafer is placed in the chamber, the reservoirs are above and below the major surfaces of the wafer. Sufficient space is allowed in the reservoir so that if gas or liquids are inserted into the chamber through inlets in the reservoir, the reservoir is of sufficient capacity to ensure that the pressure across the surface of the wafer is substantially uniform. In various embodiments, the depth of the reservoir may be selected to meet the requirements of the wafer to be cleaned. If there are many holes through the wafer, higher flower rates may be required which will result in the need for a reservoir with greater depth to ensure pressure equalization across the wafer.

In some embodiments, the shape of the reservoirs includes one or more baffles, or other contours. Such baffles may be integral with the chamber portions, or may be separate elements that are attached to the inner surfaces of the upper and/or lower chamber portions. Such baffles, or other contours facilitate the mixing of fluids inserted into the chamber, particularly when there is a transition between different processing fluids. Further, such baffles may reduce or eliminate local pressure differentials in regions of the wafer that might otherwise result from the force of fluid injected into the chamber through the inlets therein.

In various embodiments, the shape of the reservoir is chosen so as to reduce or minimize the volume of fluid in the chamber while still maintaining substantially uniform pressure across the whole area of the wafer (e.g., by having a convex chamber surface where the chamber is shallower near the center, and deeper around the edge where the fluid inlets are positioned). Lower volumes of fluid in the chamber will facilitate the rapid transition from one fluid to another during a cleaning sequence.

The chamber may include one or more mechanical supports that can physically support the center, or close to the center of the wafer on either or both of the upper or lower sides. These supports allow much greater pressure differentials to be applied across the wafer without risk of structurally damaging the wafer, thus allowing either higher flow rates, or smaller holes to be cleaned, or both. Because of the physical contact of the support to the wafer surface, if desired, a small blank area where no devices are to be fabricated may be incorporated on the surface of the wafer and positioned so as to align with the mechanical support.

An overflow drain ring is created in the lower wall of the chamber, just outside the radius of the mounting ring in the lower chamber surface. In the event that liquid leaks out past the wafer from either the upper or lower reservoir during operation, the liquid will be collected in the drain ring. In one illustrative embodiment, the drain ring has an extraction hole at a low point in the ring to allow evacuation of the fluid.

In an alternative embodiment, the chamber is configured with an O-ring seal outside the radius of the drain ring and the mounting ring. This O-ring is positioned such that when the wafer is firmly clamped by the upper and lower mounting rings, a gas seal is created around the perimeter of the chamber. The volume between the mounting rings and the outer O-ring may include an exhaust outlet to remove any gases that might leak or escape around the edge of the wafer when gas is being forced into one of the reservoirs. The system may also be configured with a pressurized gas supply to the volume just inside the O-ring. This may be used to create a back pressure on the contact points between the mounting rings and the wafer so as to minimize leakage of fluids from the reservoirs around the edge of the wafer.

Movement of Fluids Into and Out of the Chamber

Fluids may be injected into the upper and/or lower reservoirs through one or more inlets into the chamber. The inlets may be in the sides of the reservoir, or in the upper or lower surfaces of the reservoirs. The inlets are positioned so that local pressure differentials on the wafer that may be caused by the rapid flow of fluid into or out of the chamber resulting from pumping of fluids into the chamber, are reduced or eliminated. In one embodiment, this reduction or elimination of local pressure differentials is achieved by ensuring the jet of fluid coming from an inlet is directed substantially parallel to the surface of the wafer, rather than directly at the wafer surface. Further, the inlets may be configured so that they create turbulence within the reservoir. Turbulence facilitates mixing of chemicals, which is useful when there is a transition between two chemicals. This turbulence-induced mixing helps to produce substantially uniform concentrations of the different chemicals over the whole exposed surface of the wafer.

Embodiments of the present invention generally include outlets, which are structurally similar to the inlets, in the upper and/or lower reservoirs. Inlets and outlets may be configured to exchange functions by using valves to control the flow of fluids into and out of the reservoirs. In some embodiments, the inlets and outlets are connected to a system of valves and pumps that allow different chemicals, or combinations of chemicals, to be sequentially pumped into or out of either the upper or lower reservoir. It will be appreciated that in various embodiments, the pressure applied to the fluids entering the system may be precisely controllable by the pumps. In some embodiments, the outlets may be connected to a vacuum, or more generally a source of pressure that is less than the pressure within the reservoir. It will be appreciated that a range of pressures that are less than standard atmospheric pressure, but still greater than vacuum, may be obtained by the use of well-known pressure management techniques. Vacuum, or low pressure (i.e., pressure less than that of the reservoir) may be used to, among other things, accelerate removal of fluid from the chamber. It will be further appreciated that the movement of fluids (liquids or gases) into or out of the reservoirs may be achieved by mechanisms other than pumps. Any suitable means for moving the fluids, such as but not limited to, pneumatic or hydraulic, may be used, and arranged for example as a bellows, diaphragm, or any similar configuration.

It is noted that the number of inlets and outlets, and the size of each inlet and outlet is selected to be appropriate for the particular processing application. In some embodiments, such inlet and outlet dimensions are predetermined and fixedly formed in the chamber. In other embodiments, the inlet and outlet dimensions are adjustable and are set prior to the predetermined dimension for a particular process prior to performing that process. The present invention contemplates both manually adjustable and automatically adjustable inlet dimensions.

Operation of the System

When the chamber is open, a wafer is inserted onto a mounting position in the lower chamber. A contoured lip may be used to ensure precise positioning. The chamber is then closed around the wafer, and the wafer is tightly held, around an annular region located on the major surfaces at the outer circumferential edge of the wafer, by contact rings built into the upper and lower chamber surfaces.

In this illustrative embodiment, the amount of pressure applied to the wafer surfaces in order to create a seal is adjustable by the pneumatic system that closes the chamber. Sufficient pressure must be exerted onto the wafer surface to create a seal around the edge of the wafer. It is noted that in some embodiments, the seal is not required to be perfect, as long as the seal is sufficient to allow an adequate pressure differential across the wafer during the injection and removal of the fluids and/or gases used for the cleaning operation, or similar wafer processing operations.

By adjusting the pressure of liquids and/or gases injected on one side of the wafer, and the outlet configuration, and possibly outlet vacuum on the other side of the wafer, a pressure differential may be created across the wafer. This pressure differential will force fluid and/or gas to flow through the holes that go through the wafer.

Fluids can be inserted either from the top reservoir down, or from the bottom reservoir up depending on specific processing requirements. For example, if injecting liquids through the wafer, fluids may be inserted into the bottom reservoir and extracted in the upper reservoir. If it is necessary to replace liquids in the chamber by gases, gas can be pumped into the upper chamber, and the liquid and subsequently gas removed out of the lower chamber. Embodiments of the present invention may be used with a broad range of cleaning and etching fluids, and may be used for particle removal, contaminant removal, and/or wet etching of the holes through the wafer, and/or the surfaces of the wafer.

For certain processing applications, it may be necessary to execute a rapid change from one processing fluid to another processing fluid. When fully sealed, the rate of flow of a new chemical into the system is generally limited by the rate that fluid can be forced through the holes in the wafer. Depending on the relative size of the reservoirs and the flow rate through the wafer, this could result in extended periods where a mixture of chemicals will be present in one of both of chambers. In order to accomplish a more rapid change of fluids in the chamber, the chamber may be configured such that there are both inlets and outlets open in either or both of the upper and lower reservoirs. In such an arrangement, fluid can be pumped into the chamber, and fluid extracted out of the chamber on the same side of the wafer at the same time, effectively flushing out the contents of the chamber quickly, allowing a more rapid transition between different processing chemicals. After completion of the flushing process, the outlets in the reservoir may be closed, and the pumping pressure and rate through the inlets adjusted again to ensure optimal processing of fluid through the wafer holes.

It is noted that various embodiments provide for controlling pressure and rate of flow into the chamber through the inlets, and the amount of vacuum and flow rate out of the chamber, and the controls are typically set so as to avoid any damage to the wafer being processed.

In some embodiments, it is necessary to wet process the through-holes without affecting the horizontal surfaces of the wafer. To accommodate this requirement, protective coatings are applied to the horizontal surfaces of the wafer. If only one side of the wafer requires protection, a flow of inert fluid (e.g., a steady flow of ultra pure water) can be maintained across the surface of the side of the wafer in which the active fluid is exiting.

After wet processing of the wafer and through-holes, it may be necessary to dry the wafer. This can be accomplished by replacing the liquid processing fluids with gas. The rate of gas flow in the through-holes may be controlled by the pressure differential across the wafer. To ensure that there is sufficient gas flow to remove liquids from the upper and lower surfaces of the wafer, inlets and outlets may be opened in each reservoir to ensure that there is adequate gas flow across the horizontal surfaces of the wafer. The gas may be heated, or the chamber may include heating elements in its walls to ensure appropriate temperature of gas flow through the wafer.

In order to improve cleaning efficiencies, the system may incorporate ultrasonics in the chamber walls. Various embodiments include introducing ultrasonic energy, or vibrations, into the cleaning liquids.

In order to avoid water marks and to ensure full removal of the processing liquids from the major surfaces of the wafer and from the surfaces of the through-holes, the final wet processing step may include an organic solvent, or other highly volatile liquid. This liquid will be used to force the previous processing fluid out of the chamber, and out of the through-holes. Upon complete removal of the processing liquids by the volatile liquid, gas may be injected into the chamber, and the volatile chemical evaporated and removed out of the system. Note that this is made possible, and can be accomplished safely because the chamber provides a sealed system.

All functions of the system (chamber open and close, valves controlling selection of fluids to be pumped into and out of the chambers, pump flow rates and pressures) may be automated. This allows the development and operation of a sequence of processing steps with controlled conditions, and controlled transitions between the steps.

In an alternative embodiment, rather than establishing a substantially uniform pressure against a major surface of a wafer, a pressure gradient, either static or dynamically varying, is established to facilitate wafer processing operations. Such pressure gradients may be obtained by, for example, adjusting the pressure with which various pumps deliver processing chemicals to the wafer.

In a further alternative embodiment, the processing chamber, or one or more of its constituents components, are adapted for use with integrated circuits of a particular design. In other words, the number, size, and placement of the inlet and outlet ports are selected to optimize the system performance for wafers having particulars design layouts.

In a further alternative embodiment, the inlets consist of directionally oriented jets. In some embodiments, the directionally oriented jets direct the flow of processing chemicals in a fixed direction, whereas other embodiments may include directionally oriented jets the direction of which are controllable.

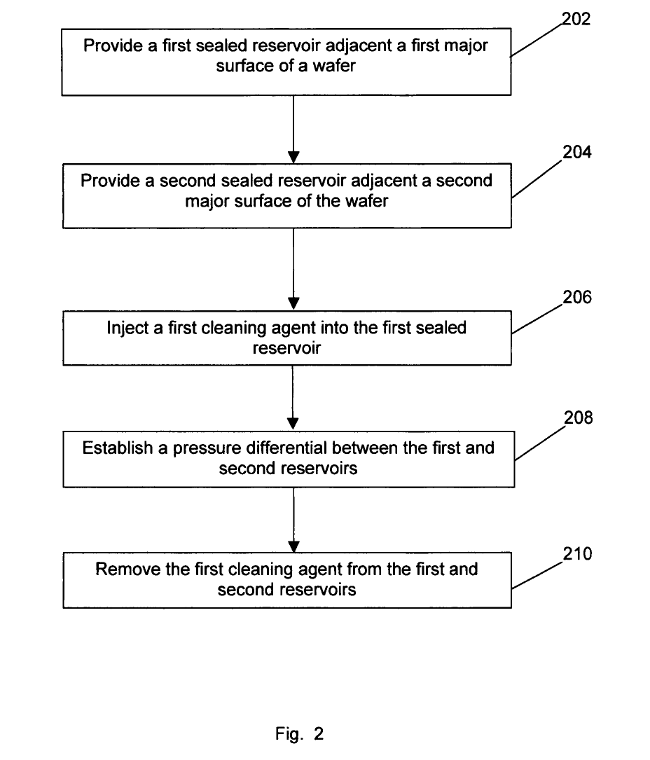

Referring to FIG. 2, an illustrative method of cleaning through-holes in a semiconductor wafer, in accordance with the present invention includes providing 202 a first sealed reservoir adjacent a first major surface of a wafer; providing 204 a second sealed reservoir adjacent a second major surface of the wafer; injecting 206 a first cleaning agent into the first sealed reservoir; establishing 208 a pressure differential between the first and second reservoirs; and removing 210 the first cleaning agent from the first and second reservoirs; wherein the first sealed reservoir includes at least one inlet, and the second sealed reservoir includes at least one outlet. It will be appreciated that injecting the cleaning agent comprises introducing the cleaning agent in any suitable manner through one or more inlet ports of the chamber.

Conclusion

Various embodiments of the present invention provide methods and apparatus for post-etch cleaning of through-holes in a wafer including the creation of a pressure differential across the wafer. More broadly, embodiments of the present invention provide methods and apparatus for chemical processing operations on substrates, such as, but not limited to, semiconductor wafers wherein a greater pressure is exerted on one major surface of the substrate as compared to a second major surface thereof.

An advantage of some embodiments of the present invention is effective cleaning of high aspect ratio through-holes due to the pressure differential across the wafer.

An advantage of some embodiments of the present invention is that rapid evacuation of processing chemicals is facilitated by a pressure differential across the wafer.

It is to be understood that the present invention is not limited to the embodiments described above, but encompasses any and all embodiments within the scope of the subjoined Claims and their equivalents.

What is claimed is:

1. A method of chemically processing through-holes in a semiconductor wafer, comprising:
providing a first sealed reservoir adjacent a first major surface of a wafer;
providing a second sealed reservoir adjacent a second major surface of the wafer;
introducing a first chemical processing agent into the first sealed reservoir;
establishing a pressure differential between the first and second reservoirs; and
removing the first chemical processing agent from the second reservoir;
wherein the first sealed reservoir includes at least one inlet, and the second sealed reservoir includes at least one outlet.

2. The method of claim 1, wherein the first sealed reservoir further includes at least one outlet, and the second sealed reservoir further includes at least one inlet.

3. The method of claim 1, wherein injecting a first chemical processing agent into the first sealed reservoir comprises pumping the first chemical processing agent through the at least one inlet in the first sealed reservoir.

4. The method of claim 1, wherein providing a first sealed reservoir adjacent a first major surface of a wafer comprises placing the wafer between an upper chamber portion and a lower chamber portion; and applying pressure to the wafer from both the upper and lower chamber portions.

5. The method of claim 1, wherein establishing a pressure differential between the first and second sealed reservoirs includes introducing one or more processing chemicals into the first sealed reservoir and evacuating at least a portion of the atmosphere from the second sealed reservoir.

6. The method of claim 3, wherein removing the first chemical processing agent from the first and second sealed reservoirs includes applying vacuum to the first and second sealed reservoirs through at least one outlet in each of the first and second sealed reservoirs.

7. The method of claim 3, wherein removing the first chemical processing agent from the first and second sealed reservoirs includes introducing a gas into at least one of the first and second sealed reservoirs through the respective at least one inlet.

8. The method of claim 1, wherein at least one of the first and second sealed reservoirs includes one or more baffles.

9. The method of claim 1, further comprising injecting a second chemical processing agent and creating turbulence.

10. The method of claim 1, further comprising injecting an organic solvent subsequent to injecting the first chemical processing agent.

11. The method of claim 1, further comprising activating an ultrasonic energy source disposed within at least one of the first and second sealed reservoirs and introducing ultrasonic energy into the first chemical processing agent.

12. The method of claim 1, further comprising activating a heating source disposed within at least one of the first and second sealed reservoirs and heating the contents thereof.

13. The method of claim 1, wherein the first chemical processing agent is one selected from the group consisting of a chemical that acts to etch the surfaces of a through-hole in a wafer, a chemical that acts to clean the surfaces of a through-hole in a wafer, a chemical that acts to plate the surfaces of a through-hole in a wafer, and a chemical that acts to passivate the surfaces of a through-hole in a wafer.

14. A method of chemically processing a semiconductor wafer, comprising:
providing a first sealed reservoir adjacent a first major surface of a wafer;
providing a second sealed reservoir adjacent a second major surface of the wafer;
introducing a first processing chemical into the first sealed reservoir;
establishing a pressure differential between the first and second reservoirs; and
removing the first processing chemical from at least the first reservoir;
wherein the first sealed reservoir includes at least one inlet, and at least one outlet.

15. The method of claim 14, wherein the first processing chemical is one selected from the group consisting of a chemical that acts to etch the surfaces of a wafer, a chemical that acts to clean the surfaces of a wafer, a chemical that acts to plate the surfaces of a wafer, and a chemical that acts to passivate the surfaces of wafer.

16. The method of claim 14, further comprising introducing one or more gases into the first sealed reservoir, subsequent to introducing the first processing chemical.

17. The method of claim 16, further comprising heating the one or more gases.

18. A method of cleaning through-holes in a substrate, comprising:
providing a first sealed reservoir adjacent a first major surface of a substrate;
providing a second sealed reservoir adjacent a second major surface of the substrate;
introducing a first chemical processing agent into the first sealed reservoir;
establishing a pressure differential between the first and second reservoirs; and
removing the first chemical processing agent from the second reservoir;
wherein the first sealed reservoir includes at least one inlet and at least one outlet, and the second sealed reservoir includes at least one inlet and at least one outlet.

19. The method of claim 18, wherein establishing a pressure differential between the first and second sealed reservoirs comprises introducing one or more processing chemicals into the first sealed reservoir and evacuating at least a portion of the atmosphere from the second sealed reservoir.

20. The method of claim 19, further comprising introducing an organic solvent into the first sealed reservoir subsequent to introducing the first chemical processing agent.
